(19) United States
(12) Patent Application Publication
(10) Pub. No.: US 2016/0148558 A1
(43) Pub. Date: May 26, 2016

(54) PERSONAL DISPLAY SYSTEMS

(71) Applicant: Fos Labs, Inc., Millbrae, CA (US)

(72) Inventors: Jonathan J. Ernst, Santa Clara, CA (US); Michael Lee, Millbrae, CA (US); Christopher Jason Birgers, Cupertino, CA (US)

(73) Assignee: Fos Labs, Inc., Millbrae, CA (US)

(21) Appl. No.: 14/952,743

(22) Filed: Nov. 25, 2015

Related U.S. Application Data
(60) Provisional application No. 62/085,204, filed on Nov. 26, 2014.
(60) Provisional application No. 62/258,218, filed on Nov. 20, 2015.

(51) Int. Cl. G09G 3/32; G06F 3/147; G09G 3/20; G06F 3/01

(52) U.S. Cl. CPC G09G 3/32; G06F 3/017; G06F 3/147; G09G 3/2096; G09G 2354/00; G09G 2370/06

(57) ABSTRACT

A personal display system may include a LED panel having a controller, a plurality of displayable patterns being stored in a memory of the controller. The controller may be in communication with an information device, such as a smart phone, such that a communication from the information device causes the controller to display a selected one of the displayable patterns on the LED panel. Communication from the information device may be carried out using gestures.

### CROSS-REFERENCES

This application claims the benefit of the following applications: (1) U.S. Provisional Patent Application Ser. No. 62/085,204, which was filed on Nov. 26, 2014 and entitled “Personal Output Systems;” and (2) U.S. Provisional Patent Application Ser. No. 62/258,218, which was filed on Nov. 20, 2015 and entitled “Personal Output Systems.” The complete disclosures of the above applications are hereby incorporated by reference for all purposes.

### INTRODUCTION

As computers and personal information devices become ubiquitous, more and more data is collected and generated about users' environments and activities. At times, such information may be useful to the user but the user is unable to access the device. Often, such information would be useful to nearby individuals, but is difficult to easily communicate or broadcast. At the same time, display technologies exist to provide information in human-readable form. These displays may be cumbersome or stationary with respect to the user. Additionally, the displays are typically static, or unchangeable from the perspective of an individual user. A need exists for comfortable, low-cost personal informational displays that allow user interaction, as facilitated by an information device.

### SUMMARY

Personal display systems and methods according to the present teachings permit wearable or mountable display panels that may be controlled by a user via an information device, e.g., a smart watch or smart phone. Benefits of these systems and methods may include hands-free control of displayed patterns on a LED panel coupled to a host.

In some examples, a method for displaying information may include coupling a personal display system to a host object, the personal display system including a light emitting diode (LED) display panel having an array of LEDs; storing information including a plurality of displayable patterns in a control system associated with the LED panel; communicating triggering information from an information device to the personal display system; and in response to the triggering information, causing the LED display panel to display at least one of the displayable patterns by changing a visual state of one or more of the LEDs.

In some examples, a personal display system may include a host object wearable by a user; a flexible LED panel having a controller and coupled to the host object; an information device in electronic communication with the controller; and a plurality of displayable patterns stored in a memory of the controller, wherein the controller is configured such that a communication from the information device triggers a display of a selected one of the displayable patterns.

In some examples, a method for communicating displayed information may include storing a plurality of displayable patterns in a memory of a controller of a flexible LED panel; removably attaching the LED panel to a host; and triggering the controller to display a selected one of the plurality of displayable patterns by communicating triggering information from an information device to the controller of the LED panel.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative personal display system in accordance with aspects of the present disclosure.

FIG. 2 is a plan view of an illustrative light emitting diode (LED) panel and associated control board suitable for use in a personal display system in accordance with aspects of the present disclosure.

FIG. 3 is an exploded side elevation view of the LED panel of FIG. 2.

FIG. 4 is an assembled side elevation view of the LED panel and control board of FIG. 2.

FIG. 5 is rear isometric view of an illustrative personal display system coupled to a belt assembly wearable by a user.

FIG. 6 is a rear isometric view of the belt assembly of FIG. 5, with the personal display system detached.

FIG. 7 is a partial rear view of an illustrative personal display system coupled to an article of clothing worn by a user.

FIG. 8 is a partial rear view of an illustrative personal display system coupled to a bag carried by a user.

FIGS. 9-14 depict various illustrative arm gestures configured to be communicated to a personal display system.

FIG. 15 is a flow chart depicting steps of an illustrative method for controlling a personal display system using gestures.

### DESCRIPTION

### Overview

Various aspects and examples of a personal display system capable of wireless communication with an information device, as well as related methods, are described below and illustrated in the associated drawings. Unless otherwise specified, a personal display system and/or its various components may, but are not required to, contain at least one of the structure, components, functionality, and/or variations described, illustrated, and/or incorporated herein. Furthermore, unless clearly excluded, the process steps, structures, components, functionalities, and/or variations described, illustrated, and/or incorporated herein in connection with the present teachings may be included in other similar display systems, including being interchangeable between disclosed embodiments. The following description of various examples is merely illustrative in nature and is in no way intended to limit the disclosure, its application, or uses. The advantages provided by the examples and embodiments described below are illustrative in nature and not all examples and embodiments provide the same advantages or the same degree of advantages.

In general, a personal display system in accordance with aspects of the present disclosure may include a flexible LED array or matrix configured to display any of a variety of messages, emoji, emoticons, symbols, and/or the like. The LED array may be controlled by a control board. The control board may include various hardware, firmware, and/or software modules configured to allow user input via manual interface and/or electronic communication from an electronic information device. Such information devices may include a smartphone or wearable computer. The LED array may be enclosed in or attached to a host object, such as a belt, article of clothing, container, bag, vehicle, etc. In some examples, the personal display system may be controllable wirelessly, e.g., via an app on a smartphone paired with the display system via Bluetooth® low energy (LE). In some examples, the personal display system may be controllable using gestures. Gestures may be performed and/or detected by a device such as a smartphone or wearable device (e.g., a smartwatch, smartband, or activity tracker).

Aspects of the personal display system may be embodied as a computer method, computer system, or computer program product. Accordingly, aspects of the personal display system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the personal display system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device. A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the personal display system may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the personal display system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the personal display system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### EXAMPLES, COMPONENTS, AND ALTERNATIVES

The following sections describe selected aspects of exemplary personal display systems, as well as related systems and/or methods. The examples in these sections are intended for illustration and should not be interpreted as limiting the entire scope of the present disclosure. Each section may include one or more distinct inventions, and/or contextual or related information, function, and/or structure.

Illustrative System:

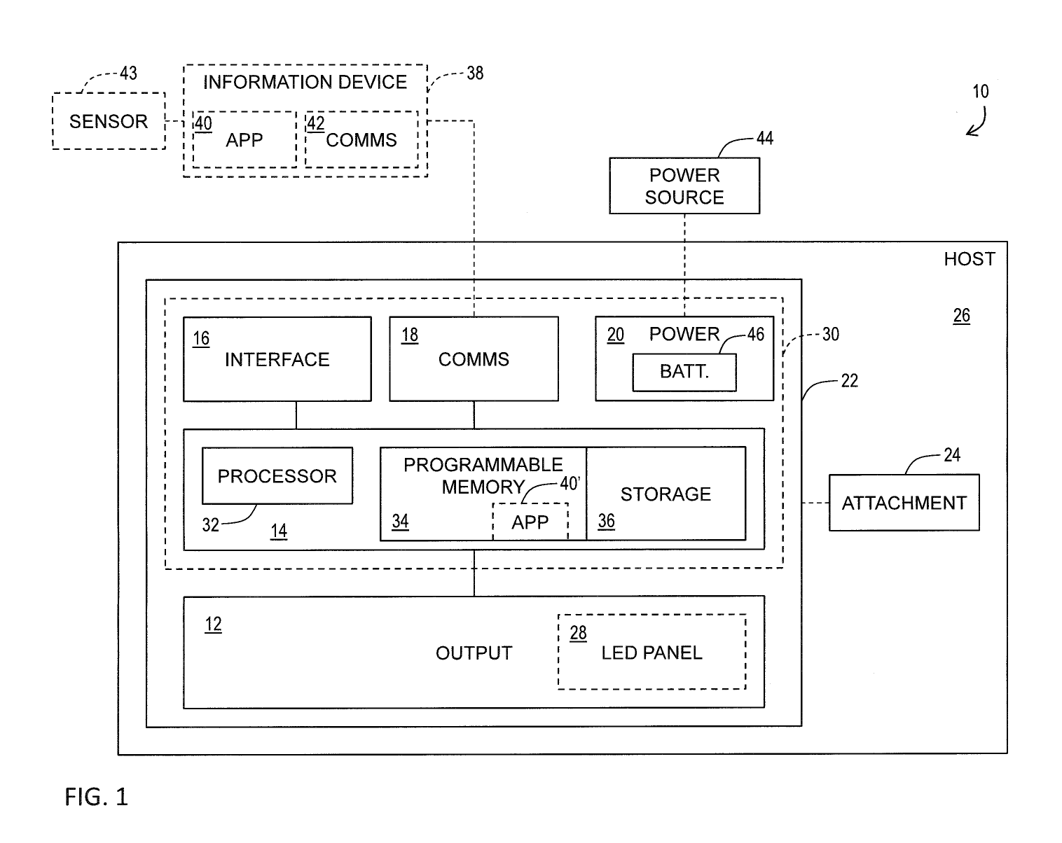

As shown in the schematic diagram of FIG. 1, this section describes a personal display system 10, which is an example of the personal display system described above. Unless explicitly excluded, personal display system 10 may include one or more components and/or one or more functions of other personal display systems described herein.

Referring now to FIG. 1, system 10 may include an output assembly 12, a control assembly 14 controlling the output assembly, an interface portion 16, a communications assembly 18, and a power assembly 20. System 10 may include a housing 22, configured to support and/or contain other elements of the system. Furthermore, system 10 may include an attachment portion 24 for coupling system 10 to a host 26. Although system 10 is described as a display system, output assembly 12 may include other outputs (e.g., audio and/or haptic outputs) either in addition to or instead of visual display elements.

Output assembly 12 may include any suitable devices and/or structures configured to produce a human-perceptible output. For example, output assembly 12 may include visual elements (e.g., one or more LEDs, display screens, color-changing materials), audio or sound elements (e.g., one or more speakers, buzzers, tone generators), and/or tactile elements (e.g., one or more vibration or rumble generators, haptic feedback mechanisms, pop-up buttons). Output assembly 12 may produce one or more output signals, as controlled by a controller (described below). In some examples, output assembly 12 may include a LED panel 28. LED panel 28 may include any suitable matrix or array of LEDs (e.g., daylight viewable LEDs) configured to display information processed by control assembly 14.

In some examples, output assembly 12 may be configured to display or otherwise output information selected by or relating to an activity of the user. For example, information may be stored in and/or communicated to system 10 (as described below), and displayed or otherwise presented using output assembly 12. Such information may include sensed or measured information, such as footstep counts, distance traveled, speed, elevation, temperature, wind speed, and the like. Such information may include selected or programmed information, such as prepared messages, images, safety warnings, directional indicators, and the like. Output may be triggered by any suitable method, such as by a timer, a time of day, a sensed event, a threshold value, and/or the like.

Control assembly 14, interface portion 16, communications assembly 18, and/or power assembly 20 may be grouped or collocated on a control board 30. For example, electronic components may be mounted or otherwise attached to a printed circuit board (PCB) to form a PCB assembly (PCBA) comprising the control board. Control assembly 14 may include any suitable devices and/or structures configured to control and communicate with output assembly 12. For example, control assembly 14 may include a processor 32, a programmable memory 34, and/or a persistent storage module 36. Processor 32 may include any suitable semiconductor-based electronic processing unit, chip, microchip, or integrated circuit (IC) commonly used in the industry to execute instructions, among other functions. Programmable memory 34 may include any suitable electronic storage device configured to store instructions and to be re-programmable. For example, programmable memory 34 may include an erasable programmable read only memory (EPROM) device. Persistent storage module 36 may include any suitable electronic memory store configured to retain stored information when power is cycled. For example, storage module 36 may include a hard disk drive, a solid state drive (SSD), flash drive, hybrid drive, or the like, or any combination of these.

Accordingly, processor 32 (also referred to, alone or in combination with memory components, as a controller) may be utilized to control the output of information on output assembly 12 by storing information and/or executing commands stored in memory. For example, aspects of methods described herein may be executed by processor 32 as instructions stored in memory (e.g., memory 34 and/or storage 36).

Control assembly 14 may be in electronic communication with interface portion 16 and/or communications assembly 18 to receive instructions and information regarding outputs and changes thereto. Interface portion 16 may include any suitable mechanical or virtual user interface configured to allow a user to communicate information to the system, or to carry out one or more functions of the system itself. For example, a user interface may include one or more manipulable controls, such as a lever, dial, switch, slider, pushbutton, keypad, and/or knob, any of which may be implemented mechanically or virtually, such as via a graphical user interface (GUI) on a screen or other display. Any manipulable control may be manipulated by a body part of the operator, such as by a hand, a foot, and/or one or more fingers or toes. In some examples, a user interface may include a voice interface capable of speech recognition, through which the operator may provide voice commands to the controller. In some examples, a user interface may include a wearable computing device, such as an article of clothing or a wrist-or head-mounted interface. In some examples, a user interface may include any suitable device implanted on or in the operator's body.

Communications assembly 18 may include any suitable device and/or structure configured to facilitate communication of information between system 10 and an external electronic device, also referred to as an information device 38. Communications assembly 18 may include devices configured to transmit and/or receive wireless or wired communications with information device 38. For example, communications assembly 18 may include one or more antennas, transceivers, connectors for wired reception and/or transmission of data, data exchange devices, and/or the like, or any combination of these. Communications assembly 18 may also include supporting components, such as a filter circuit, an encryption/decryption circuit, and/or an integrated circuit (IC) chip for processing signals (e.g., a Bluetooth® chip). In some examples, communications assembly 18 may include a WiFi communication device configured to connect to a local wireless network, including connecting to one or more information devices 38 on the network.

Information device 38 may include any suitable electronic device configured to communicate data electronically, either through wired or wireless methods. Information device 38 may include a mobile phone, a smart phone, a wearable computer, a fitness or activity tracker, a portable/mobile electronic device, a tablet, a smart watch, a personal digital assistant (PDA), a personal computer (PC), a desktop computer, a laptop, a server, and/or the like. Information device 38 may include one or more software applications 40 (also referred to as apps), configured to facilitate control and communication of information between the information device and system 10. Information device 38 may further include a communications module 42 configured to transmit and/or receive information, such as a Bluetooth® module, cellular data transceiver, WiFi capability, or USB cable connection. Information device 38 may include one or more sensors 43, such as orientation and/or motion sensors. For example, sensors 43 may include one or more accelerometers, gyroscopes, gravity sensors, microphones, WiFi detectors, proximity sensors, temperature sensors, and/or the like.

Power assembly 20 may include any suitable devices and/or structures configured to provide an electrical interface between system 10 and a power source 44. Power source 44 may include any suitable source of electrical power, such as a battery, an electrical outlet, a capacitor, a fuel cell, and/or the like, or any combination of these. Additionally or alternatively, power source 44 may be included in power assembly 20 (e.g., on control board 30 or within an associated enclosure). For example, a battery or battery pack 46 may be included in system 10. In some examples, the battery(ies) may be rechargeable, such as through an electrical cable or interface provided by power assembly 20. In some embodiments, power assembly 20 may share or overlap features with communications assembly 18. For example, a USB or micro-USB cable connector may be included in system 10, such that both electrical power and data communication are facilitated by the same component.

In some examples, power assembly 20 may also include one or more components configured to shape, filter, amplify, transform, and/or rectify power received from power source 44 and/or battery 46, to ensure such power is usable by the various components of the display system. For example, the power assembly may include one or more voltage booster (or voltage multiplier) devices, rectifiers, filters, and/or the like. In some examples, power from power source 44 may be provided in one or more forms to one or more components of system 10. For example, power may be provided through power assembly 20 to components of communications assembly 18, interface portion 16, and/or output assembly 12.

Housing 22 may include any suitable enclosure or other structure configured to support and/or contain one or more components of system 10. In some examples, housing 22 further supports and/or contains other objects, such as information device 38, power source 44, etc. Housing 22 may include rigid and/or flexible elements. In some examples, housing 22 may include a pouch or case. The housing may be made of any suitable materials, such as one or more fabrics and/or one or more polymer materials (such as flexible or pliable plastic). In some examples, housing 22 may include an enclosure in the form of a slit, reclosable container, or pouch, and may further include any suitable structure to secure the contents within the enclosure while allowing access to the contents, such as a zipper or a hook-and-loop fastener. The enclosure may be configured to hold information device(s) 38 alone, or may additionally or alternatively hold one or more other components of system 10.

In some examples, housing 22 may include multiple enclosures with one or more of the enclosures being readily accessible to a user, and one or more other enclosures being configured to store other components of system 10. Housing 22 may include any suitable number and arrangement of compartments and/or enclosures. Although information device(s) 38 are depicted to be exterior to housing 22, an information device may alternatively, or additionally, be located at least partially within the housing.

In some examples, LED panel 28 of output assembly 12 may be removable from housing 22 and/or viewable when stored in the housing. For example, LED panel 28 may be contained within an enclosure, such as a portion of the housing. In some examples, the enclosure may include a window, such as a flexible clear plastic covering or translucent fabric, for viewing the LED panel when placed in the enclosure. In general, output assembly 12 may be positioned such that outputs from the assembly may be perceptible by the user and/or one or more other persons.

Attachment portion 24 may include any suitable structure configured to couple system 10 to host 26. Host 26 may include a portion of a user, such as a body part (e.g., head, neck, torso, leg, arm), or may include an article of clothing, a vehicle, and/or an accessory associated with a user. For example, attachment portion 24 may include one or more members configured to strap, buckle, snap, button, adhere, or otherwise fasten onto a body part (e.g., a user's waist), a portion of a vehicle (e.g., a car visor), or a sports accessory (e.g., a snowboard).

In some examples, one or more attachment members may be configured to attach to each other and be adjustably fastenable around a user, in the manner of a belt. Alternatively, or additionally, attachment portion 24 may be configured to be secured to and/or around other suitable portion(s) of a user. The attachment portion may include one or more clips, straps, fasteners, clasps, ties, bands, and/or any other suitable structure. In some examples, attachment assembly 24 may additionally, or alternatively, be attachable to and/or be supported by any suitable objects and/or structure. For example, the attachment portion may be attachable to, and/or be supported by, a lamp post, a street sign, a tree, a house, an office building or other structure, a furniture item, a clothing article (such as a jacket, a shirt, a vest, or a shoe), a clothing accessory (such as a bag or a necklace), a travel container (such as a backpack or suitcase), a toy (such as a plush or stuffed toy), a game, etc.

In some examples, personal display system 10 may be contained within one or more enclosures and/or compartments of a clothing article, clothing accessory, travel container, toy, game, or the like. In those examples, the system may exclude a housing and/or an attachment portion. Alternatively, attachment portion 24 may be attachable to any suitable portion of a clothing article, clothing accessory, travel container, toy, game, etc. In some examples, the clothing article, clothing accessory, travel container, toy, game, etc. may include one or more molded portions and one or more components of the personal display system may be incorporated with the molded portion(s).

System 10 may function to display or otherwise output information on output assembly 12, based on one or more possible sources of information. For example, textual, graphical, or other messages or signals may be communicated from information device 38 to communications assembly 18, and then communicated to control assembly 14. Control assembly 14 may then store and/or cause the display of the message(s) on LED panel 28. In some examples, a plurality of messages may be stored in a buffer in storage module 36. These messages may be called up (e.g., in sequence) by processor 32 to be displayed on LED panel 28. In some examples, the plurality of messages may be received from information device 38. In some examples, the plurality of messages may be communicated through a wired interface (e.g., a USB port). In some examples, the plurality of messages may be input by a user through interface portion 16.

Information may be displayed or otherwise output based on an activity. For example, when the user is walking, running, or cycling, the output assembly may output information from the information device(s). This information may be from one or more sensors associated with the information device(s), such as heart rate and speed, and/or from one or more other information sources and/or information device(s). Additionally, the information may be from one or more programs or apps 40 of the information device(s), such as applications that generate text and/or images. Alternatively, or additionally, app 40 of the information device(s) may provide a user interface to receive user's inputs as to what information to display. Information may be displayed to other people, such as when the user is responsible for crowd control and/or the safety of others. In some examples, app 40 may be (or may be in communication with) a navigation application, such as when global positioning system (GPS) information is used to provide directions for a user. In these examples, system 10 may be used to output direction-related information, such as turn directions (left/right) and street names. In some examples, control assembly 14 may comprise aspects of app 40, as indicated at 40′ in FIG. 1.

Alternatively or additionally, output assembly 12 may be configured to output one or more files stored in the control assembly, in response to input received from information device(s) 38. For example, a first stored file and/or pattern may be outputted by the output assembly when the user is walking, running, or cycling above a certain threshold speed, while a second stored file and/or pattern may be outputted by the output assembly when the user is walking, running, or cycling below a certain threshold speed. Additionally, or alternatively, a first stored file and/or pattern may be outputted by the output assembly when the user performs a first gesture with one or more of his or her limbs, while a second stored file and/or pattern may be outputted by the output assembly when the user performs a second gesture different from the first gesture. Although the output assembly is described to include first and second stored files, the output assembly may include any suitable number of stored files, including three or more stored files.

Illustrative LED Matrix and Controls:

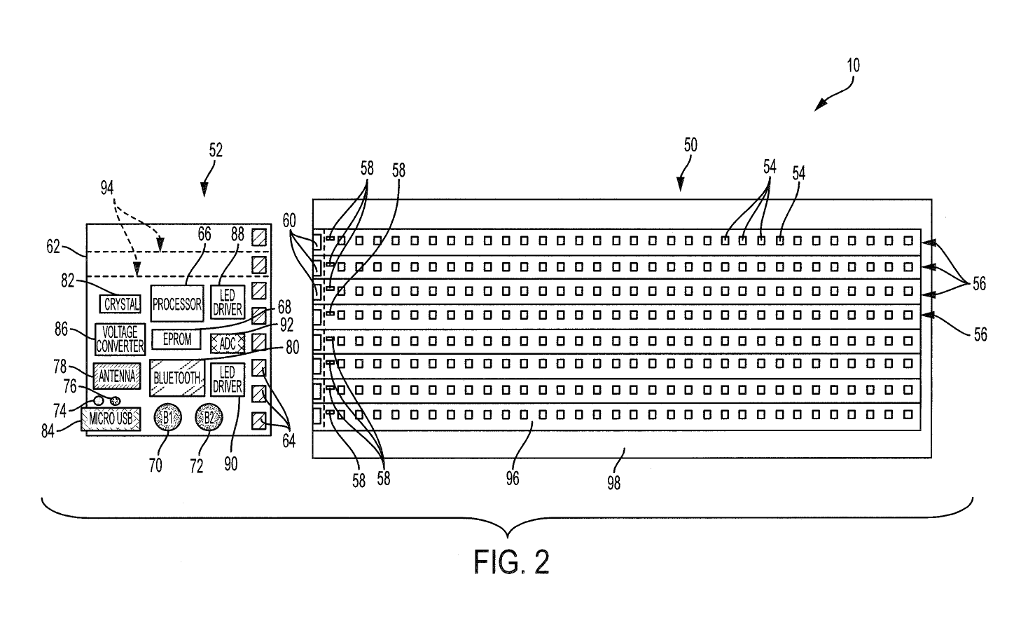

As shown in FIGS. 2-4, this section describes a LED panel 50 and associated control board 52. LED panel 50 and control board 52 are examples of LED panel 28 and control board 30, respectively, described above. Accordingly, similar components may be labeled with similar reference numbers.

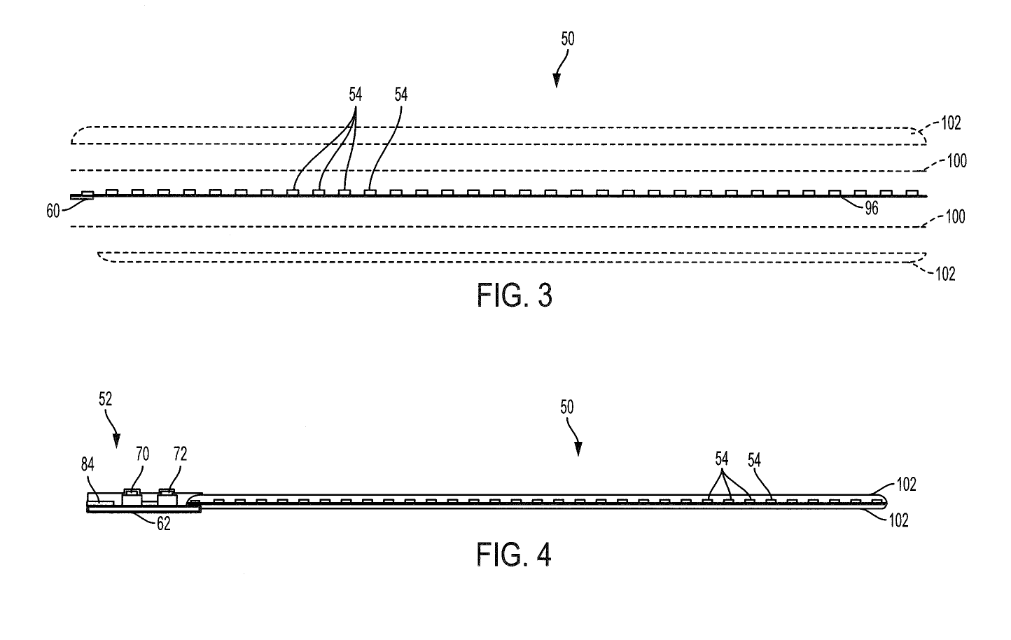

FIG. 2 shows LED panel 50, also referred to as a LED matrix or LED array, and its associated control board 52, in plan view. FIGS. 3 and 4 show these components in a side or edge view, where FIG. 3 is an exploded view and FIG. 4 is assembled. Some elements of the control board and LED panel may be omitted in each drawing, for simplicity of explanation.

In general, LED panel 50 may include any suitable array of LEDs or other light-emitting elements. LED panel 50 may be flexible, shape-able, and/or pliable, such that LED panel 50 may be incorporated into, attached to, or worn on any suitable host. In the example depicted in FIGS. 2-4, LED panel 50 includes an eight by 32 array of LEDs 54, arranged in lengthwise strings or rows 56, also referred to as channels or control lines. Each horizontal string 56 is electrically connected to control board 52 through a respective control resistor 58 and contact point 60. The resistance value of each resistor 58 may determine row orientation and length.

Control board 52 may include any suitable components configured to communicate with external device(s) and control LED panel 50 accordingly. In the example depicted in FIGS. 2-4, control board 52 includes a PCB 62, a set of contact points 64 for electrically connecting to corresponding contact points 60 on the LED panel, and various electronic components comprising a control assembly, interface portion, communications assembly, and power assembly, all substantially as described above. For example, the control assembly of control board 52 may include a processor 66 and an EPROM 68. The interface portion of control board 52 may include a pair of pushbuttons 70 and 72 and a pair of status lights 74 and 76. The communications assembly of control board 52 may include an antenna 78, a Bluetooth® chip 80, and a crystal filter 82, as well as a micro-USB connector 84. The power assembly of control board 52 may include the micro-USB connector, a voltage converter 86, a pair of LED drivers 88 and 90. An analog-to-digital converter (ADC) 92 may be utilized to read LED row resistor(s) 58 to determine display size and orientation.

One or more portions of PCB 62 may be removable, as indicated by break points 94. For example, top portions of PCB 62, with associated contact points 64, may snap off if desired. This may be appropriate, for example, if LED panel 50 includes six or seven rows of LEDs 54, rather than eight.

LED panel 50 may further include a substrate 96, which may be a flexible or bendable PCB. Alternatively or additionally, a fabric layer may be provided. In some examples, such as the one shown in FIG. 2, a fabric layer 98 may extend beyond the LEDs, to form a border or strip around the LED array. This may facilitate attachment of the LED array to a host, such as by sewing or adhesive. In some examples, such as the one shown in FIGS. 3 and 4, an impregnated fabric electromagnetic interference (EMI) shield 100 may at least partially enclose LED panel 50. This impregnated fabric or cloth may include metal (e.g., copper) threads woven into the cloth to create a sort of Faraday cage to prevent electromagnetic interference. As shown in FIGS. 3 and 4, LED panel 50 may be further encased or covered in a resin-based coating or covering 102. Covering 102 may be configured to permit viewing of the LEDs while also providing protection from the elements (e.g., water resistance, etc.). As shown in FIG. 4, a covering 104 may also be present on control board 52 when assembled with the LED panel.

Illustrative Hosts and Embodiments:

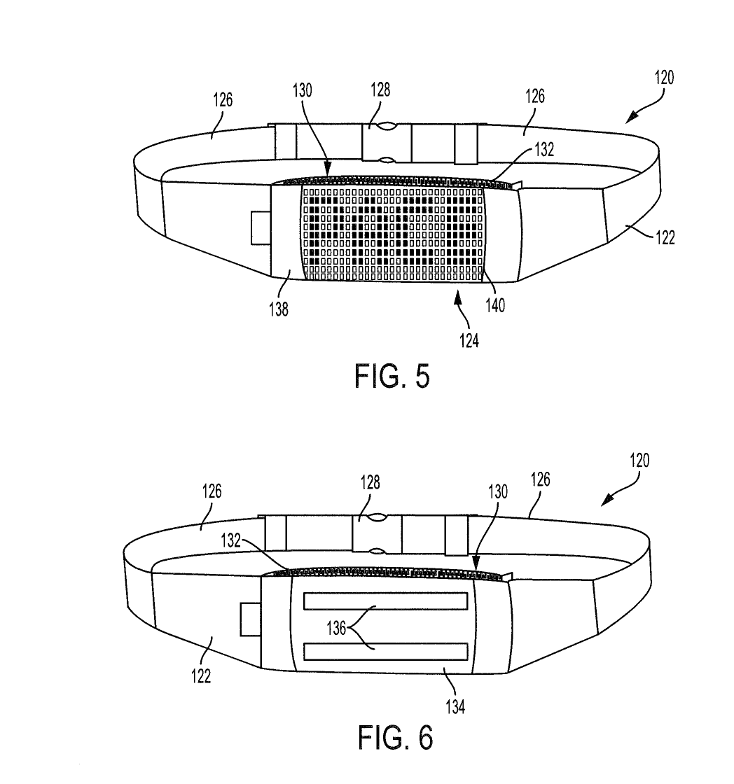

As shown in FIGS. 5-8, this section describes a various embodiments of personal display systems in accordance with aspects of the present disclosure, incorporated into or associated with illustrative hosts. These embodiments are examples of system 10 and host 26, described above, and may incorporate aspects of LED panel 50 and/or control panel 52. Accordingly, similar components may be labeled with similar reference numbers.

FIGS. 5 and 6 show an illustrative embodiment of system 10, in the form of a belt display system 120. System 120 includes a belt portion 122 and a display portion 124. FIG. 6 shows the belt portion with the display portion removed. Belt portion 122 may include any suitable strap or straps 126, which may be adjustably fastened around the waist, torso, or other body part of a user. Accordingly, straps 126 may be fastenable by a buckle 128. Belt portion 122 may further include a pouch 130 that may be recloseably sealed by a zipper 132 or other suitable closure device. An attachment portion 134 of belt portion 122 may include attachment mechanism, such as hook-and-loop fastener strips 136.

Corresponding hook-and-loop strips, or any other suitable attachment mechanism, may be present on display portion 124, to facilitate coupling of the display portion to the belt portion. In some examples, the display portion may, additionally or alternatively, be placed into a compartment on the belt portion. Display portion 124 may include a LED display panel 138 and enclosure 140. Enclosure 140 may include a window 142, in the form of a transparent or translucent layer, configured to allow viewing of the LED panel. A control board (not shown) and other components may be present (e.g., a power source, such as a battery pack) as described above. These components may be housed within the same enclosure 140 and/or in one or more compartments of belt portion 122.

Accordingly, belt display system 120 may be used to display messages when worn by a user. For example, during a footrace or other event, a user may wear belt display system around his or her torso, with the LED panel facing rearward. Other participants may then be able to read any messages displayed on the panel. These messages may include words such as “PACE” as shown in FIG. 5, such as when the user wearing the belt system is running or walking at a selected pace. Messages may also reflect a sensed value, such as ambient temperature or the user's heart rate.

Turning to FIG. 7, an illustrative embodiment of system 10 is shown integrated into an article of clothing. In this example, a LED display panel 150 is sewn, adhered, or otherwise affixed to a rear surface of a shirt 152 worn by a user 154. LED display panel 150 may be substantially as described above with respect to system 10 and/or LED panel 50. Accordingly, a control board or other controller may be collocated and/or incorporated into an enclosure of LED display panel 150.

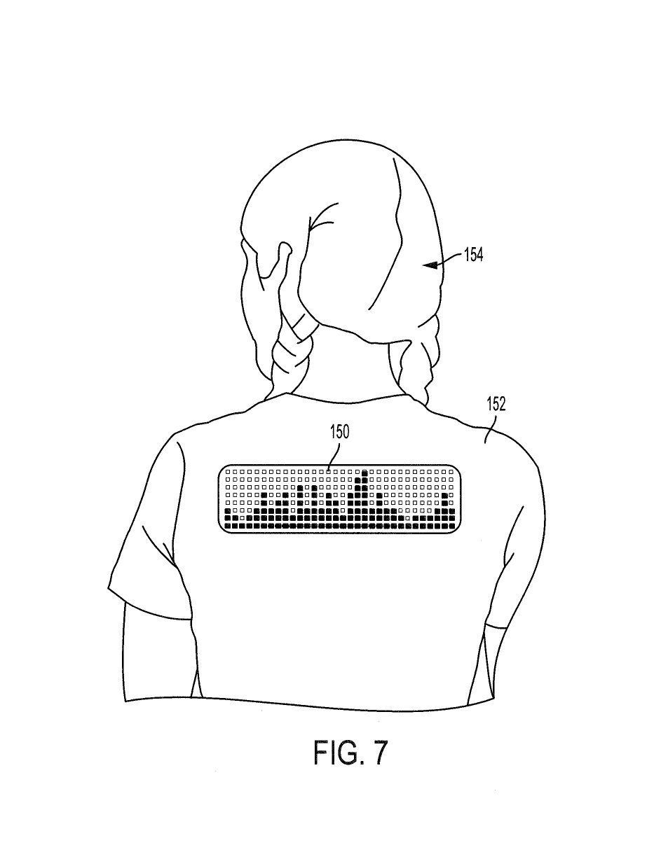

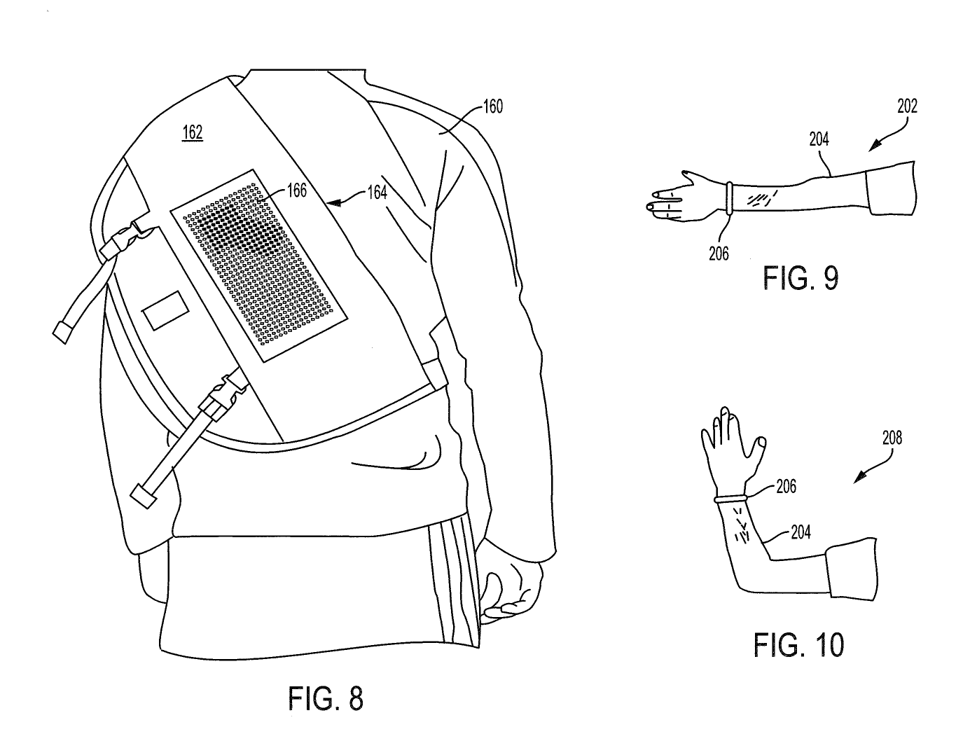

FIG. 8 depicts a user 160 carrying a bag 162 having a personal display system 164. System 164 is an example of system 10, and includes a LED display panel 166 visible on a rear-facing surface of the bag. System 164 may otherwise be substantively as described with respect to system 10, including a control assembly, interface portion, communications assembly, and power assembly, not shown. A housing 168 may enclose LED display panel 166, and may include one or more attachment portions configured to couple the LED display panel to bag 162. Bag 162 is depicted as an over-the-shoulder bag, such as those carried by bicycle riders and messengers. However, any suitable bag or article of luggage may be used as a host for system 164.

Illustrative Method Using Gesture Controls:

This section describes steps of an illustrative method 200 for communicating with a personal display system using gestures; see FIGS. 9-15. Aspects of personal display systems, such as system 10, may be utilized in the method steps described below. Where appropriate, reference may be made to previously described components and systems that may be used in carrying out each step. These references are for illustration, and are not intended to limit the possible ways of carrying out any particular step of the method.

FIGS. 9-14 depict illustrative arm gestures for communicating information to a personal display system. In general, gesture information may be communicated by a wearable or handheld information device, such as a wristband, smart watch, fitness tracker, or the like. As depicted in FIGS. 9-14, the gestures may be carried out by gesturing with the information device, rather than by systems that detect movements at a distance, e.g., using cameras or infrared sensors. Accordingly, gestures may be detected by one or more sensors on the information device, such as orientation sensors (e.g., gyroscopes, gravity-sensing devices), accelerometers, light sensors, microphone, and/or the like, or any combination of these. Motion information may be detected by the sensor(s) and communicated (e.g., wirelessly) to the communications assembly of a personal display system. This motion information may be processed by the information device to varying degrees, depending for example on the processing power available on that device, and/or may be processed by the control assembly of the personal display system. For example, an operating system and/or app on the information device (e.g., a smart watch) may process the motion information and provide an application programming interface (API) that interprets the motion information and provides layers of abstraction. In other examples, only a raw stream of motion information may be communicated.

In general, such motion and gesture information may be used to trigger one or more informational or other displays on a LED panel of the personal display system. These information displays may be referred to as patterns. A plurality of patterns, for example, may be stored in a memory of the personal display system's controller, along with information regarding which gestures should trigger display of each of the patterns.

Any suitable gesture or series of detectable movements, including timed pauses or holds, may be used to communicate information to the personal display system. For example, FIG. 9 depicts an illustrative gesture 202, in which a left arm 204 of a user is held straight out, away from the body, for a length of time. An information device, in the form of a smart wristband or smart watch 206 is worn on the wrist of arm 204. Gesture 202 may communicate, for example, that the user wishes to turn left. In response, a personal display system, such as the bag-mounted example of system 164, may respond by displaying a left-pointing arrow (as shown in FIG. 8). Similarly corresponding patterns may be displayed in response to other gestures.

FIG. 10 depicts another illustrative gesture 208, which includes bending the elbow of arm 204, such that the forearm is held substantially vertical. This gesture may include first performing gesture 202, and may indicate a desire of the user to turn right.

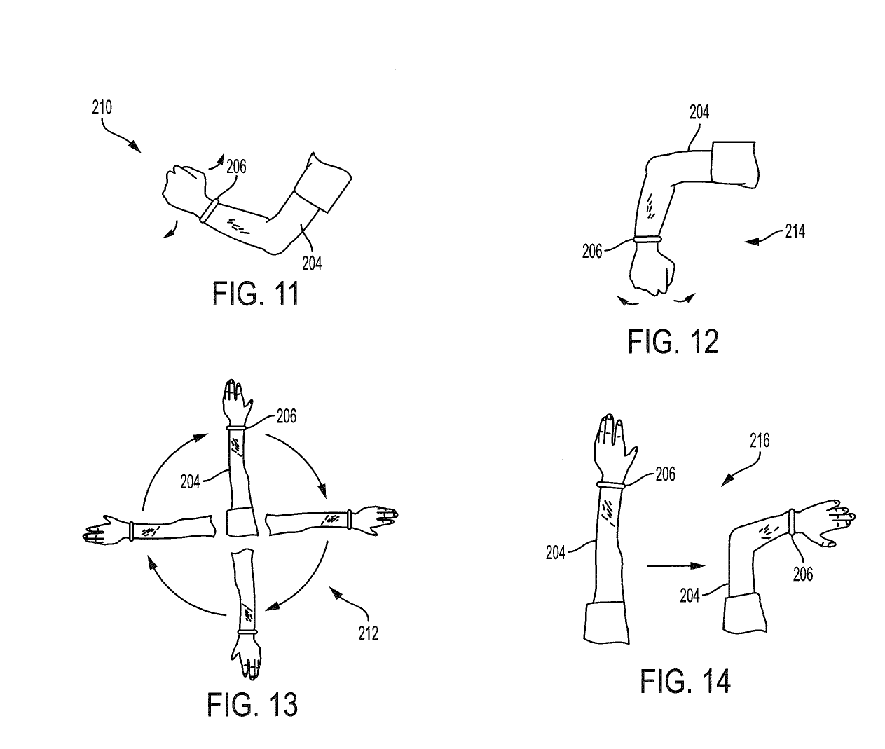

FIG. 11 depicts another illustrative gesture 210, in which the hand is moved directly out from the body and shaken or pivoted a selected number of times within a selected time period (e.g., four times in less than two seconds). This gesture may indicate a desire by the user to change to a next pattern on the display, or to change modes of the display.

FIG. 12 depicts another illustrative gesture 212, in which the hand is moved to a downward-hanging position and shaken or otherwise moved rhythmically a selected number of times within a selected time period (e.g., four times in less than two seconds). This gesture may indicate a desire by the user to signal caution.

FIG. 13 depicts another illustrative gesture 214, in which the hand is moved away from the body and fully rotated clockwise a selected number of times (e.g., twice) within a selected period of time (e.g., 2.5 seconds). This gesture may indicate a desire by the user to begin display of a series of patterns, or to start a counter.

FIG. 14 depicts another illustrative gesture 216, in which the arm is held straight and then at a roughly ninety degree angle in front of the body, in the position used to look at a watch. In some examples, a smart watch may automatically recognize this “watch reading” gesture. This gesture may indicate a desire by the user to wake up the display, begin monitoring, and/or initiate a pattern.

Although various gestures have been described, with various corresponding desired actions, any intention may be mapped to any detectable gesture, along with a corresponding pattern or word display. Additionally, any suitable device may be used, and may be associated with any suitable part of a user's body. For example, a head-mounted information device may be used to detect nodding of the head, looking left or right, etc.

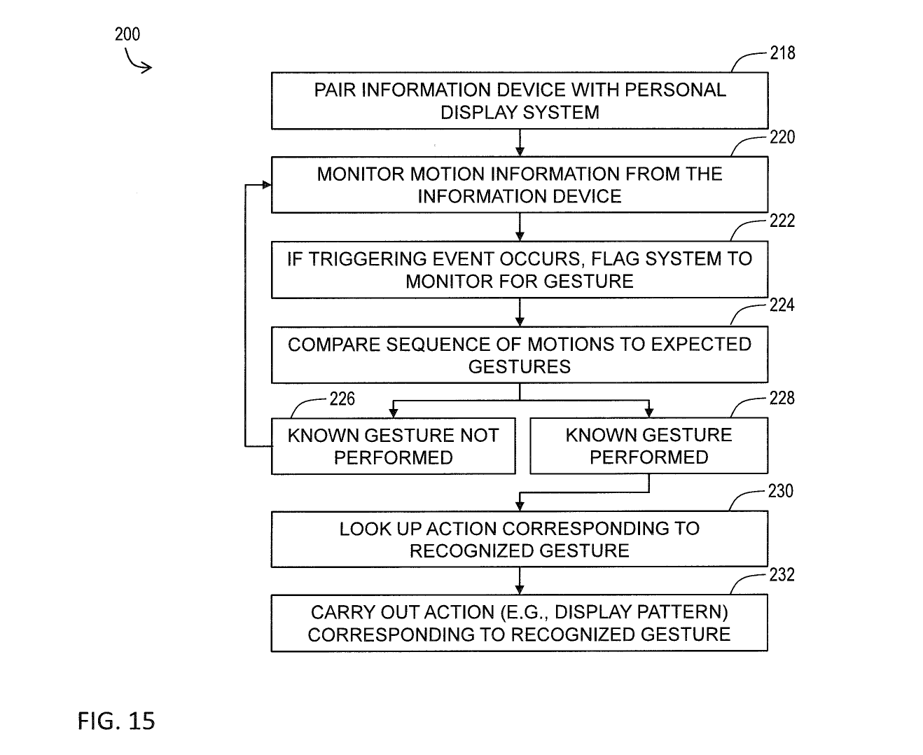

FIG. 15 is a flowchart illustrating steps performed in method 200, which is an illustrative method for controlling a personal display system using gestures. FIG. 15 may not recite the complete process or all steps of the method. FIG. 15 depicts multiple steps that may be performed in conjunction with personal display systems described above. Although various steps of method 200 are described below and depicted in FIGS. 9-15, the steps need not necessarily all be performed, and in some cases may be performed in a different order than the order shown.

At step 218, a gesturable or wearable information device is paired with a personal display system, such that the device and system are in communication with each other. For example, a wrist-mounted device may be paired with a personal display system via Bluetooth® LE, using standard pairing procedures.

At step 220, motion-and/or orientation-related information from the information device is monitored by the personal display system. This information may be pre-processed and/or abstracted by applications or operating systems on the information device and/or the personal display system. For example, a gesture-recognition application may run on a smart watch. In some examples, the wearable device may have insufficient processing power for such an application. In those examples, gesture-recognition may be performed by the control assembly of the personal display system.

At step 222, an app on the information device or personal display system recognizes a triggering event and raises a flag. In some examples, a triggering event may include a first motion in a sequence of motions comprising a gesture. In some examples, a triggering event may include a known gesture, such as the “watch reading” gesture of FIG. 14. Recognizing a single known gesture (e.g., gesture 216) as the trigger may be more efficient, as the app would not need to monitor for the first movement of all known gestures. Moreover, such known gestures are often recognized inherently by the device operating system. In response to the recognized event, a flag may be raised in the app.

At step 224, the app performs active comparison of movements and/or orientations to expected gesture patterns. These gesture patterns may be expected sequences of movements stored in memory, in correlated relationship with selected actions or respective display patterns. A buffer or other memory structure is utilized to store movements as they happen. For example, if movement A is performed, then movement B, then movement C, the buffer may store A-B-C. The app may then determine if A-B-C is an expected gesture. If not, the next movement D may be stored, such that the buffer contains A-B-C-D. Again, this sequence may be compared to known gestures.

At step 226, if an unknown or unexpected movement is detected, or if a timer expires before an expected gesture is completed, execution of the app returns to the monitoring phase of step 220. For example, the app may recognize a sequence of two movements in a three-movement gesture (e.g., A-B of gesture A-B-C). However, the third movement may be different than expected (e.g., A-B-A), or may be performed after the expiration of a selected time limit. In either case, the gesture was not performed “correctly,” and the app ceases attempting to find a matching gesture. In some examples, this may include clearing the buffer.

At step 228, if a series of movements and/or orientations is detected that matches an expected gesture (i.e., a gesture stored in memory), the app raises a flag indicating recognition and identifying the recognized gesture.

At step 230, the action correlated with the recognized gesture is retrieved, e.g., looked up in a stored table correlating the gestures to the actions. This action may be to display a selected pattern, symbol, or textual message. For example, if the “left turn” gesture is detected, the action may be “display left arrow.”

At step 232, the action is carried out. For example, the stored pattern corresponding to the known gesture may be displayed on the LED panel of the personal display system. In some examples, this action may be maintained until a next gesture is detected. In some examples, the action is performed for a selected duration. In some examples, the action is performed for a selected duration and then a next action is performed, such as executing a sequence of patterns beginning with the one that was gestured.

Selected Examples and Embodiments:

This section describes additional aspects and features of personal display systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A method for displaying information, the method including:

coupling a personal display system to a host object, the personal display system including a light emitting diode (LED) display panel having an array of LEDs;

storing information including a plurality of displayable patterns in a control system associated with the LED panel;

communicating triggering information from an information device to the personal display system; and

in response to the triggering information, causing the LED display panel to display at least one of the displayable patterns by changing a visual state of one or more of the LEDs.

A1. The method of A0, wherein the host object is a wearable object.

A2. The method of any of paragraphs A0 through A1, wherein the wearable object comprises a belt.

A3. The method any of paragraphs A0 through A2, wherein communicating triggering information includes performing a known gesture using the information device.

A4. The method of A3, wherein the information device is a smart watch.

A5. The method any of paragraphs A0 through A4, wherein the LED display panel is flexible.

A6. The method of any of paragraphs A0 through A5, wherein storing the information includes storing a plurality of respective gestures corresponding to the plurality of displayable patterns.

A7. The method of A6, wherein each of the gestures includes at least one expected movement.

B0. A method for controlling a LED display, the method comprising:

attaching a panel to a host, the panel having an array of LEDs and a controller configured to control patterns displayed by the array of LEDs;

storing in the controller a plurality of displayable patterns;

communicating information wirelessly from an information device to the panel; and

in response to receiving the information communicated by the information device, causing a selected one of the displayable patterns to be displayed using the array of LEDs.

B1. The method of B0, wherein the host comprises an article of clothing.

B2. The method of any of paragraphs B0 through B1, wherein the information communicated from the information device to the panel includes a value sensed by a sensor associated with the information device.

B3. The method of any of paragraphs B0 through B2, wherein the information communicated from the information device to the panel includes an action desired by a user.

B4. The method of B3, wherein the information is communicated by a user performing a selected one of a plurality of gestures using the information device.

B5. The method of B4, wherein the gesture must be performed within a selected length of time.

C0. A method for communicating displayed information, the method comprising:

storing a plurality of displayable patterns in a memory of a controller of a flexible LED panel;

removably attaching the LED panel to a host; and

triggering the controller to display a selected one of the plurality of displayable patterns by communicating triggering information from an information device to the controller of the LED panel.

C1. The method of C0, wherein the displayable patterns comprise textual messages.

C2. The method of any of paragraphs C0 through C1, wherein the host comprises a portion of a vehicle.

C3. The method of any of paragraphs C0 through C2, wherein the host comprises a sports accessory.

C4. The method of any of paragraphs C0 through C3, wherein communicating triggering information includes performing a gesture using the information device.

C5. The method of C4, wherein storing the displayable patterns includes storing a set of gestures respectively corresponding to the displayable patterns.

C6. The method of C5, wherein the controller compares a sequence of motions sensed by the information device to the set of gestures.

D0. A personal display system comprising:

a host object wearable by a user;

a flexible LED panel having a controller and coupled to the host object;

an information device in electronic communication with the controller; and

a plurality of displayable patterns stored in a memory of the controller;

wherein the controller is configured such that a communication from the information device triggers a display of a selected one of the displayable patterns.

D1. The system of D0, wherein the information device comprises a wearable computer.

D2. The system of any of paragraphs D0 through D1, wherein the host object comprises an adjustable strap.

D3. The system of any of paragraphs D0 through D2, further comprising a metal-impregnated fabric at least partially enclosing the LED panel.

D4. The system of any of paragraphs D0 through D3, further comprising a fabric layer extending beyond a perimeter of the LED panel.

D5. The system of D4, wherein the LED panel is coupled to the host object by the fabric layer.

E0. In some examples, a personal display system may stream content real-time from a Bluetooth® low energy (LE) device. Such content may include: fitness statistics (such as heart rate, steps, and/or distance); speed; music information (such as track names, artist name, lyrics, and/or music visualizations); and notifications (such as notifications from phone, text, email, and/or other applications). For example, output system may display information from social media streams, such as Twitter, Facebook, G+, and/or Instagram. The system may display safety warnings, such as radiation levels. Users may include safety workers and road workers.

F0. A personal display system may have accelerometer-based features, such as turn signals and movement tracking. In some examples, the system may have accessibility features, such as real-time translation and sign language display.

F1. The system or method of any other paragraph, including an output display having any suitably sized viewable area (e.g., two inches by eight inches).

F2. The system or method of any other paragraph, including an output display with any suitable pixel spacing (e.g., LEDs spaced not less than 0.25 inches apart).

F3. The system or method of any other paragraph, wherein a display includes daylight-viewable LEDs in any suitable colors.

F4. The system or method of any other paragraph, including a power supply powered from a power source including a battery. For example, a battery that lasts between three and six hours at full brightness.

F5. The system or method of any other paragraph, including a detachable LED panel, e.g., a panel sized less than three inches by 10.5 inches.

F6. The system or method of any other paragraph, including a LED panel assembly that is removable from a closeable pouch.

F7. The system or method of any other paragraph, including a number of displayable patterns that may be displayed in a sequence, each pattern being displayed for a suitable time period (e.g., 30 seconds or less).

F8. The system or method of any other paragraph, including a default set of preloaded patterns and/or actions that are displayed or carried out, e.g., in the event of a loss of communication.

F9. The system or method of any other paragraph, wherein a housing includes a closeable pouch configured to hold and contain a personal information device, such as a standard smart phone with a screen up to five inches.

F10. The system or method of any other paragraph, including a mounting mechanism for a LED panel assembly that does not interfere with the viewable area.

F11. The system or method of any other paragraph, including circuitry sufficient to provide the ability to update firmware of the personal display system through a USB or micro-USB port.

F12. The system or method of any other paragraph, wherein a LED panel has a unique ID that is identifiable via Bluetooth® interface. Multiple panels may be connectable to a single Bluetooth® device.

Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A method for displaying information, the method including:
coupling a personal display system to a host object, the personal display system including a light emitting diode (LED) display panel having an array of LEDs;
storing information including a plurality of displayable patterns in a control system associated with the LED panel;
communicating triggering information from an information device to the personal display system; and
in response to the triggering information, causing the LED display panel to display at least one of the displayable patterns by changing a visual state of one or more of the LEDs.

2. The method of claim 1, wherein the host object is a wearable object.

3. The method of claim 2, wherein the wearable object comprises a belt.

4. The method of claim 1, wherein communicating triggering information includes performing a known gesture using the information device.

5. The method of claim 4, wherein the information device is a smart watch.

6. The method of claim 1, wherein storing the information includes storing a plurality of respective gestures corresponding to the plurality of displayable patterns.

7. The method of claim 6, wherein each of the gestures includes at least one expected movement.

8. A personal display system, comprising:
a host object wearable by a user;
a flexible LED panel having a controller and coupled to the host object;
an information device in electronic communication with the controller; and
a plurality of displayable patterns stored in a memory of the controller,
wherein the controller is configured such that a communication from the information device triggers a display of a selected one of the displayable patterns.

9. The system of claim 8, wherein the information device comprises a wearable computer.

10. The system of claim 8, wherein the host object comprises an adjustable strap.

11. The system of claim 8, further comprising a metal-impregnated fabric at least partially enclosing the LED panel.

12. The system of claim 8, further comprising a fabric layer extending beyond a perimeter of the LED panel.

13. The system of claim 12, wherein the LED panel is coupled to the host object by the fabric layer.

14. A method for communicating displayed information, the method comprising:
storing a plurality of displayable patterns in a memory of a controller of a flexible LED panel;
removably attaching the LED panel to a host; and
triggering the controller to display a selected one of the plurality of displayable patterns by communicating triggering information from an information device to the controller of the LED panel.

15. The method of claim 14, wherein the displayable patterns comprise textual messages.

16. The method of claim 14, wherein the host comprises a portion of a vehicle.

17. The method of claim 14, wherein the host comprises a sports accessory.

18. The method of claim 14, wherein communicating triggering information includes performing a gesture using the information device.

19. The method of claim 18, wherein storing the displayable patterns includes storing a set of gestures respectively corresponding to the displayable patterns.

20. The method of claim 19, wherein the controller compares a sequence of motions sensed by the information device to the set of gestures.
